(19) United States
(12) Patent Application Publication
(10) Pub. No.: US 2008/0204234 A1
(43) Pub. Date: Aug. 28, 2008

(54) SYSTEMS AND METHODS FOR INCREASED MEMORY CAPACITY IN A LOW-POWER ENVIRONMENT

(76) Inventor: Vijay Pillai, Everett, WA (US)

Correspondence Address: PERKINS COIE LLP;PATENT-SEA, P.O. BOX 1247, SEATTLE, WA, 98111-1247, US

(21) Appl. No.: 11/680,413

(22) Filed: Feb. 28, 2007

(51) Int. Cl. G08B 13/14

(52) U.S. Cl. 340/572.1

(57) ABSTRACT

An RFID tag includes multiple memory blocks that can be independently powered. Blocks can be selected automatically, simultaneously, and/or in sequence based on a memory access request received by the RFID tag. A memory block can be selected for powering based on address data included in or derived from a memory access request. Power to a memory block can be controlled by memory block selector which activates one or more power control transistors associated with memory blocks based on the memory access request. A compatible tag reader can be configured to instruct a tag to power/unpower individual memory blocks.

### BACKGROUND

Radio frequency identification (“RFID”) chips are becoming increasingly popular in a wide range of industries. As RFID technology is applied in a range of demanding applications, there is an increasing need for RFID chips that have a large memory capacity and do not require an active power source. One of the major problems facing RFID systems today is that of limited memory capacity available on a passive RFID chip. Passive RFID chips are not actively powered and, as a result, they typically can only access relatively small amounts of memory. A large memory on an RFID chip can require a substantial standby current and such a current cannot be maintained on a passive chip.

To date, the only solution in the low power environment of a passive RFID tag has been to reduce the memory capacity. Alternatively, some developers of RFID solutions have created semi-passive RFID chips in which additional power is provided by a battery. In those systems with supplemental power, standby current for a large memory block can be provided.

For quite a few applications, however, it is desirable to perform operations on a relatively large memory in a completely passive RFID chip that does not require a battery or any other active power source, as well as to provide additional benefits.

### BRIEF DESCRIPTION OF THE DRAWINGS

FIG. 1 illustrates an RFID memory block with a power control unit.

FIG. 2 illustrates an RFID tag and a reader containing components for selectively powering memory blocks.

FIG. 3 illustrates multiple RFID memory blocks and associated power control units.

FIG. 4 illustrates a method for selectively powering memory blocks in an RFID chip.

FIG. 5 illustrates the use of combinational logic for selective powering RFID memory blocks.

The headings provided herein are for convenience only and do not necessarily affect the scope or meaning of the claimed invention.

### DETAILED DESCRIPTION

In a broad sense, systems and methods for providing power to a plurality of memory blocks into a passive RFID chip are disclosed in detail below. An on-chip RFID memory block can include an array or other arrangement of memory storage units. In some embodiments, an RFID chip can include a single memory block while in other embodiments the chip can include multiple memory blocks. Each block can be of any size and can store any number of bits. In some embodiments, a block can be configured to store anywhere from a single bit to many thousands of bits or more.

The memory blocks in passive RFID chips are typically non-volatile and are not continuously powered for read and write operations. The memory blocks described herein can be of any type of non-volatile memory or other memory that is capable of retaining its state in the absence of a standby current. An array of memory blocks can include several blocks of the same type and capacity or an array could include several blocks of different types and/or capacities.

The systems and methods described herein can be used to receive a memory access request from an RFID reader and then detect which ones of multiple memory blocks contain the relevant address space and power those blocks without powering other blocks that do not contain relevant address space. While these systems and methods are applicable to passive RFID chips, they can also be used in an actively powered RFID chip, semi-passive RFID chip, or in any other device or environment in which the power available for memory operations is limited.

### Power Control Unit

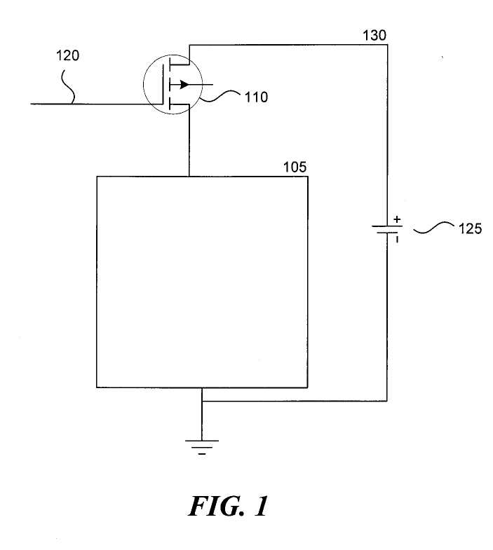

As illustrated in FIG. 1, power to a memory block 105 can be controlled on a per block basis. Memory block 105 can be coupled to a corresponding power control unit 110 that can be used to control power to memory block 105. The power control unit 110 can receive an activation control signal on signal line 120 to power up the associated memory block 105. When the power control unit 110 is activated, current from power source 125 can flow through line 130, through power control unit 110, and into the memory block 105, thereby powering it for memory access operations such as reads and writes.

While in some embodiments such as the one illustrated in FIG. 1, the power supply for an individual memory block can be turned ON and OFF by an individual power control unit, in other embodiments power to a group of multiple memory blocks can be controlled by one power control transistor. For example, some embodiments could include five groups of two memory blocks, wherein power to each group of two memory blocks is controlled by a single power control unit.

The power control unit can be any electrical device that can act as a switch to control the power provided to a memory block. In some embodiments, the power control unit can be a transistor. In embodiments where the power control unit is a transistor, the power control transistor can be any type of transistor including, but not limited to, a bipolar junction transistor or a field effect transistor. When the power control unit is a field effect transistor, the power control transistor can be controlled by a voltage applied at its gate.

### Memory Block Selector

As discussed in more detail below, a memory block selector mechanism for selecting which memory block to power can include, for example, a state machine, a demultiplexer, or combinational logic. In addition, other mechanisms for converting a memory access request to an identification of a memory block could be used. Once a memory block has been identified by any technique, the corresponding power control unit can be activated and the memory block to which it is coupled can be powered and its contents accessed.

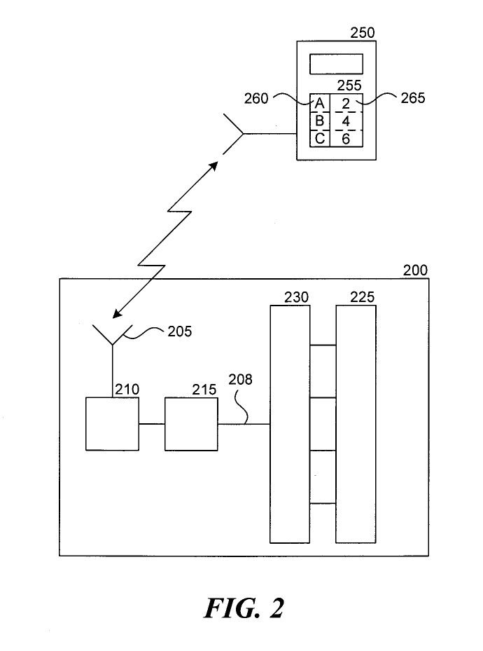

An RFID chip incorporating, among other units, a memory block selector, a power control unit, and multiple memory blocks is illustrated in FIG. 2. As illustrated, the chip 200 can receive a data signal from reader 250 through antenna 205 and transponder circuit 210. The data signal containing a memory access request is forwarded to memory block selector 215. As described in more detail below, the memory block selector 215 can determine which of the memory blocks in device memory 225 are to be powered for the memory access request. As a result of that determination, the memory block selector 215 can provide one or more signals on line or lines 208 to one or more of the power control units 230. The signal on line 208 activates the proper power control unit and causes the activated unit to provide power to the memory block in the device memory 225 to which it is coupled. As described herein, the memory block selector 215 can include any logic for receiving the memory access request and selectively powering and accessing one of multiple memory blocks. Examples of memory block selectors include demultiplexers, state machines, combinational logic, gate arrays, microcontrollers, processors, etc.

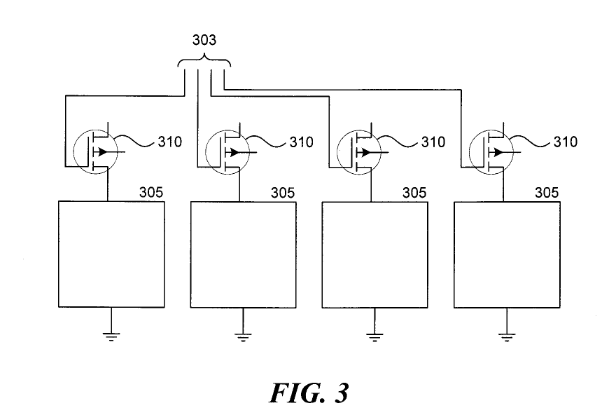

As illustrated in FIG. 3, multiple individual memory blocks 305 can be controlled by corresponding power control transistors 310. Multiple signal lines 303 can be coupled to multiple corresponding power control transistors 310 for activating the power control transistors 310. As discussed above, in alternative embodiments, any one of the power control transistors 310 could be coupled to more than one of memory blocks 305 so that multiple blocks can be controlled simultaneously from the same power control activation signal on one or more of the lines 303.

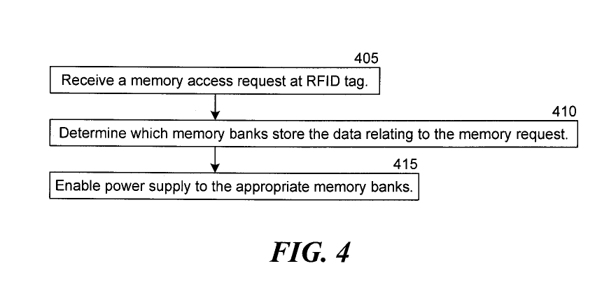

An example method of operation is illustrated in FIG. 4. In step 405, the RFID tag can receive a memory access request. The request could be a request from an external reader to read or write data. The request could also be an internally generated request to refresh data or perform another maintenance operation. In step 410, the memory block selector can determine which memory blocks store the data relating to the memory request. In step 415, power is enabled to be supplied to the appropriate memory blocks based on the determination by activating the appropriate power control unit.

In some embodiments, the memory block selector can be an internal state machine and the power control units can be controlled by the state machine. When a tag receives a command for access to a certain memory location, the state machine can determine in which of the individual memory blocks the referenced memory is located. This state machine can be incorporated into a controller in the RFID circuit or in one or more of the individual memory blocks or power control units.

With reference to FIG. 3, a demultiplexer can be used to identify the appropriate memory block to power. The output of a demultiplexer can be coupled to the gates of the power control transistors 310 by signal lines 303. The output of the demultiplexer can thereby selectively power on the corresponding memory block and the memory in that location can then be accessed. In some embodiments, the address for a read or write operation is provided to a demultiplexer. The demultiplexer can be configured to use one or more bits of the address to select a memory block. For example, a 2 to 4 demultiplexer can be used to select among four individual memory blocks. In this example, the first two bits of an address can be used to specify one of four different memory blocks.

In some embodiments, when a command is issued to a tag, the state machine can use a lookup table to determine which memory block contains the address location indicated by the command. The lookup table can be stored in any non-volatile data store on the tag and can be hard-coded or programmed in a re-writable memory.

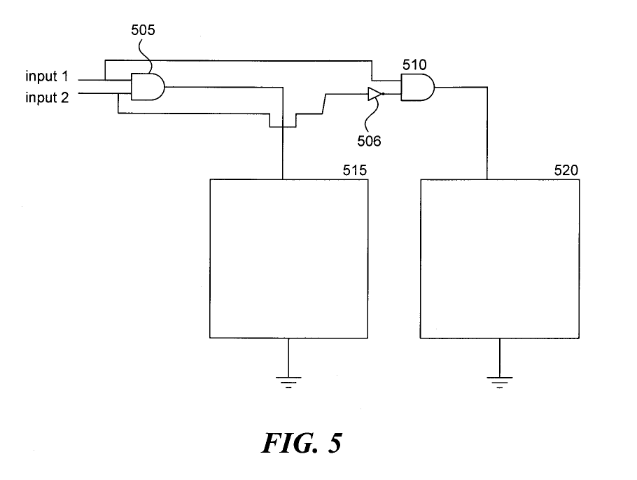

In some embodiments, combinational logic gates can be used to select and directly power memory blocks. As illustrated in FIG. 5, the outputs of multiple AND gates can be coupled to the memory blocks. In the example shown, block 515 is powered when Input1=1 and Input2=1 while block 520 is powered when Input1=1 and Input2=0. For all other combinations of Input1 and Input2, the two memory blocks 515 and 520 will not be powered. In this arrangement, the AND gate used should be capable of providing enough current to power the memory block to which it is coupled. Other types of logic gates such as, for example, NAND and NOR gates could also be used in addition to or instead of AND gates for this purpose. Similarly, while the combination logic shown in FIG. 5 includes an inverter 506, other arrangements may not require an inverter. While the embodiment illustrated in FIG. 3 does not use a power control transistor, in some embodiments, output of the AND or other logic gate can be used to control a power control transistor that is coupled to the memory blocks 515 and 520. In some embodiments, Input1 and Input2 can also be coupled to a demultiplexer operative on address data or any other functional unit that contains data from which the identification of a memory block can be determined.

In some embodiments, a state machine can be used to determine that a single memory block is to be powered and activate the power control transistor for that single memory block. Thus, only one memory block is powered on during a memory access in an RFID chip. In other embodiments, the state machine may determine that several blocks are to be accessed. In these embodiments, several power control transistors could be activated and several blocks accessed. In some of these embodiments, the several blocks are powered at the same time, and in other embodiments the blocks are powered sequentially. These systems and methods can be used to effect a sequential access to multiple memory blocks with a single memory access command. In this manner, an RFID chip can have multiple individual memory blocks, but the amount of standby current required at any point in time to access memory from the array will be the current required to access only one memory block and only one memory request need be issued to the RFID tag.

For example, a data request may request data that spans several blocks. If a data request requires access to several memory blocks, a memory access command will cause the state machine to power up the first memory block, read the data at the first memory block, then power down the first block, then power up the second memory block, read the data at the second memory block, then power down the second block. This process can be performed for as many blocks as necessary to operate on the requested data. In some embodiments, the tag can be configured so that the powering of multiple memory blocks can be performed with a single read request to the tag. Thus, a user could form a single read or write command to a tag for data which is contained in multiple blocks without having to separately form the requests so as to only reference data in a single memory block. For example, if requested data was contained in five separate memory blocks, each of the five blocks could be sequentially powered to ultimately perform a read of all of the requested data from the five memory blocks in an automatic process.

In some embodiments, to speed access to memory blocks, if a certain block is requested, the state machine can power the requested block and then automatically power the next block in an addressable memory after completion of the first request but before a second request is received. In some embodiments, the RFID chip can predict the next block to be automatically powered based on recent access to sequential or non-sequential memory addresses.

### Reader Integration

In some embodiments, an RFID reader used to read a tag need not be aware that the tag includes memory blocks that can be separately powered. In those embodiments, the reader can form a request to read or write data and the memory control unit in the tag will determine which memory blocks contain the requested data and power the appropriate blocks automatically.

In some embodiments, an RFID tag reader can be configured to be aware that tags have multiple memory blocks that can separately powered. In these embodiments, the reader can provide a command by which it specifies one or more memory blocks to be powered up and from which data should be read or modified. The reader can specify whether or not the blocks are to be powered up sequentially or simultaneously. As illustrated in FIG. 2, in some embodiments, reader 250 can be configured to include a data store 255 that associates certain types of tags 260 with the total number of memory blocks 265 the tags are capable of operating simultaneously. Such a reader can include a user interface for allowing a user to select the number of blocks to be accessed simultaneously while preventing the user from configuring the reader to attempt to access more blocks simultaneously than the chip is configured to allow. Alternatively or additionally, the reader could initially poll one or more tags to determine their type, including whether they include multiple memory blocks that can separately powered, and if so, how many of such memory blocks are so controllable. Thereafter, the reader can provide one or more appropriate signals to cause one or more memory blocks to be selectively powered.

In some embodiments, the tag can be programmed to power only a predetermined or otherwise limited number of blocks simultaneously. This limiting function can be used to prevent excessive power consumption. Thus, if a reader were to request that a greater number of blocks be powered, the tag may operate only the predetermined number of blocks. For example, if a reader specifies that 10 blocks be activated, the tag may keep only two blocks powered simultaneously. A compatible tag can be configured to perform five separate powering/unpowering cycles to read the information from the 10 blocks by accessing two blocks at a time.

A reader used for these functions can be based on a conventional reader and may also include, inter alia, an RF transmitter, an RF receiver, an antenna, an RF front end, a signal processing circuit, and an antenna connected to at least the RF front end.

### CONCLUSION

Many specific details of certain embodiments of the invention are set forth in the description and in FIGS. 1-5 to provide a thorough understanding of these embodiments. A person skilled in the art, however, will understand that the invention may be practiced without several of these details or additional details can be added to the invention. Well-known structures and functions have not been shown or described in detail to avoid unnecessarily obscuring the description of the embodiments of the invention. As used herein, one or more components “coupled” to each other can be coupled directly (i.e., no other components are between the coupled components) or indirectly (i.e., one or more other components can be placed between the coupled components).

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined or altered to provide further embodiments.

These and other changes can be made to the invention in light of the above Detailed Description. While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein.

The terminology used in the Detailed Description is intended to be interpreted in its broadest reasonable manner, even though it is being used in conjunction with a detailed description of certain specific embodiments of the invention. Certain terms may even be emphasized; however, any terminology intended to be interpreted in any restricted manner will be overtly and specifically defined as such in this Detailed Description section. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as a means-plus-function claim under 35 U.S.C sec. 112, other aspects may likewise be embodied as a means-plus-function claim. Accordingly, the inventors reserve the right to add additional claims after filing the application to pursue such additional claim forms for other aspects of the invention.

I claim:

1. An RFID tag, comprising:
a rectification circuitry configured to receive a wireless electromagnetic signal, wherein the wireless electromagnetic signal provides power to the RFID tag;
multiple memory blocks configured to store data in a non-volatile state;
at least one power control unit coupled to the memory blocks, wherein the power control unit couples the memory blocks to receive power from the rectification circuitry; and
a memory block selector configured to provide an activation signal to the at least one power control unit thereby causing it to provide power to one or more of the multiple memory blocks determined by the memory block selector, and wherein the activation signal is not provided to at least one of the at least one power control unit so that not all of the multiple memory blocks simultaneously receive power.

2. The RFID tag of claim 1, wherein at least one of the at least one power control unit is configured to control power to at least two of the multiple memory blocks.

3. The RFID tag of claim 1, wherein the memory block selector further comprises a demultiplexer configured to receive a portion of a memory address and select at least one of the multiple memory blocks based on the memory address.

4. The RFID tag of claim 1, wherein the memory block selector further comprises a lookup table for determining at least one of the at least one power control unit to activate.

5. The RFID tag of claim 1, wherein the at least one power control unit is a transistor.

6. The RFID tag of claim 1, wherein the memory block selector further comprises one or more combinational logic gates the outputs of which are coupled to the power supplies of at least two of the multiple memory blocks.

7. The RFID tag of claim 1, wherein the RFID tag is programmed so that in response to a single memory access request, multiple memory blocks will be powered in sequence so that only one block is powered at a time.

8. The RFID tag of claim 1, wherein the RFID tag is further programmed to automatically power a next sequential memory bock of the multiple memory blocks.

9. A method for selectively accessing a memory on an RFID tag, comprising:
wirelessly receiving a command to access a memory on the RFID tag, wherein the RFID tag includes multiple memory blocks;
determining at least one, but not all, of the multiple memory blocks corresponding to the memory access request; and,
providing power to the memory block determined to correspond to the memory access request.

10. The method of claim 9, further comprising automatically providing power to multiple memory blocks in sequence.

11. The method of claim 9, wherein the determination of a memory block is based on a memory address.

12. The method of claim 9, wherein the determination is performed by a lookup table.

13. The method of claim 9, further comprising automatically determining a next memory block to power based on the received memory access request.

14. The method of claim 9, wherein the memory block determined to correspond to the memory access request is the only memory block to which power is provided.

15. The method of claim 9, further comprising demultiplexing a portion of the received memory access request to determine the corresponding memory block.

16. An RFID reader, comprising:
a radio for communicating with at least one RFID tag;
a data store that associates one or more tag types with a total number of simultaneous memory block operations for a tag type;
a processor configured to generate a memory access request, wherein the processor is further configured to limit a number of simultaneous memory accesses requests generated based on the stored tag type so that only portions, and not all, of an RFID tag memory are simultaneously energized; and
a radio for transmitting the memory access request to at least some of the multiple RFID tags.

17. The RFID reader of claim 16, further comprising a user interface for receiving from a user a number of memory blocks for simultaneous access.

18. The RFID reader of claim 16, wherein the reader is configured to provide one or more commands to a tag for powering or unpowering one or more memory blocks.

19. The RFID reader of claim 16, wherein the reader is configured to poll an RFID tag to determine a number of memory blocks that are simultaneously operable and providing a command to a tag for powering or unpowering no more than the determined number of blocks.

20. A selective memory power control system for an RFID tag, comprising:
a storage means for storing data in multiple non-volatile state memory blocks; and,
a power control means for controlling power to the storage means, wherein the power control means includes means for wirelessly receiving an input signal and selectively coupling the storage means to a passive power supply, wherein the passive power supply is configured to receive and store wirelessly received electromagnetic energy, and where the selective coupling concurrently couples at least one, but not all, of the multiple non-volatile state memory blocks based on the wirelessly received input signal.
